(19) United States
(12) Patent Application Publication
(10) Pub. No.: US 2024/0166518 A1
(43) Pub. Date: May 23, 2024

(54) CARBON NANOTUBE STRUCTURE AND METHOD FOR PRODUCING CARBON NANOTUBE STRUCTURE

(71) Applicants: MITSUBISHI HEAVY INDUSTRIES, LTD., Tokyo (JP); SHINSHU UNIVERSITY, Matsumoto City, Nagano (JP)

(72) Inventors: Tomoaki SUGIYAMA, Tokyo (JP); Hidekazu NISHINO, Tokyo (JP); Toshiyasu KIYABU, Tokyo (JP); Katsumi KANEKO, Nagano City (JP)

(73) Assignees: MITSUBISHI HEAVY INDUSTRIES, LTD., Tokyo (JP); SHINSHU UNIVERSITY, Matsumoto City, Nagano (JP)

(21) Appl. No.: 18/284,008

(22) PCT Filed: Mar. 11, 2022
(86) PCT No.: PCT/JP2022/010837

§ 371 Date: Sep. 25, 2023

(30) Foreign Application Priority Data
Mar. 31, 2021 (JP) 2021-062122

(51) Int. Cl. C01B 32/174; B82Y 30/00; B82Y 40/00

(52) U.S. Cl. CPC C01B 32/174; B82Y 30/00; B82Y 40/00; C01B 2202/22; C01B 2202/26; C01P 2002/85; C01P 2004/04

(57) ABSTRACT

The carbon nanotube structure in which a plurality of carbon nanotubes are assembled includes a joining portion of end portions of carbon nanotubes and a joining portion of an end portion and a side wall portion of the carbon nanotubes.

### TECHNICAL FIELD

The present disclosure relates to a carbon nanotube structure and a method for producing a carbon nanotube structure.

Priority is claimed on Japanese Patent Application No. 2021-62122, filed on Mar. 31, 2021, the content of which is incorporated herein by reference.

### BACKGROUND ART

A carbon nanotube has attracted attention as a material which can replace metals used in power lines and signal lines because it is lightweight and has excellent properties such as conductivity, current capacity, elasticity, and mechanical strength. The carbon nanotube is used, for example, as a material for structures such as wire rod, or is added to a resin for the purpose of improving strength.

Patent Document 1 discloses an aggregate of carbon nanotubes, having a plurality of carbon nanotubes and a crosslinked structure with organic molecules between the plurality of carbon nanotubes.

### CITATION LIST

### Patent Document

Patent Document 1: Japanese Unexamined Patent Application, First Publication No. 2018-115087

### SUMMARY OF INVENTION

### Technical Problem

However, the technique disclosed in Patent Document 1 has a problem in that it is difficult to produce a three-dimensional structure because the carbon nanotubes are joined between side walls.

The present disclosure is made to solve the above-described problem, and an object of the present disclosure is to provide a carbon nanotube structure and a method for producing a carbon nanotube structure, in which a three-dimensional structure can be easily produced.

### Solution to Problem

In order to solve the above-described problem, the carbon nanotube structure according to an aspect of the present disclosure is a carbon nanotube structure in which a plurality of carbon nanotubes are assembled, the carbon nanotube structure including, between carbon nanotubes, a joining portion of end portions of the carbon nanotubes and a joining portion of an end portion and a side wall portion of the carbon nanotubes.

The method for producing a carbon nanotube structure according to an aspect of the present disclosure is a method for producing a carbon nanotube structure in which a plurality of carbon nanotubes are assembled, the method including an oxidation removal step of oxidizing and removing end portions and side wall portions of carbon nanotubes between the carbon nanotubes, and a joining step of joining the end portions of the carbon nanotubes and joining the end portion and the side wall portion of the carbon nanotubes to obtain a carbon nanotube structure.

### Advantageous Effects of Invention

With the carbon nanotube structure and the method for producing a carbon nanotube structure according to the aspects of the present disclosure, it is possible to provide a carbon nanotube structure and a method for producing a carbon nanotube structure, in which a three-dimensional structure can be easily produced.

### BRIEF DESCRIPTION OF DRAWINGS

FIG. 1 is a schematic view of a carbon nanotube.

FIG. 2 is a view showing a joining portion of an end portion of a single-layer carbon nanotube and an end portion of a single-layer carbon nanotube.

FIG. 3 is a view showing a joining portion of an end portion of a single-layer carbon nanotube and a side wall portion of a single-layer carbon nanotube.

FIG. 4 is a diagram showing nitrogen adsorption isotherms obtained by performing a nitrogen gas adsorption method on various aggregates of carbon nanotubes and carbon nanotube structures.

FIG. 5 is a diagram obtained by measuring pores and pore volumes of various aggregates of carbon nanotubes and carbon nanotube structures.

FIG. 6 is a diagram showing a light absorption spectrum of a carbon nanotube structure before and after a joining step.

FIG. 7 is a schematic view of a single-layer carbon nanotube after an oxidation removal step.

FIG. 8 is a TEM image of a single-layer carbon nanotube after the oxidation removal step.

FIG. 9 is a TEM image of the single-layer carbon nanotube after the oxidation removal step.

FIG. 10 is a diagram showing a relationship between a heating temperature, a weight loss rate, a surface area, and a pore volume in dry oxidation removal.

FIG. 11 is a diagram obtained by XPS measurement of a carbon nanotube after being subjected to dry oxidation removal at 723 K.

FIG. 12 shows a relationship between a reaction time with a 30% hydrogen peroxide solution, a weight loss rate, and a surface area in wet oxidation removal.

FIG. 13 is a diagram showing a preferred amount of linker molecules added in a joining step.

FIG. 14 is a diagram showing a preferred amount of linker molecules added in the joining step.

FIG. 15 is a diagram showing conductivity and tensile strength of various aggregates of carbon nanotubes and carbon nanotube structures.

FIG. 16 is a diagram showing a nitrogen adsorption isotherm obtained in Examples.

FIG. 17 is a diagram showing a relationship between pores and pore volumes obtained in Examples.

FIG. 18 is a diagram showing an infrared absorption spectrum obtained in Examples.

FIG. 19 is a TEM image of a carbon nanotube structure obtained in Examples.

FIG. 20 is a TEM image of a carbon nanotube structure obtained in Examples.

FIG. 21 is a TEM image of a carbon nanotube structure obtained in Examples.

### DESCRIPTION OF EMBODIMENTS

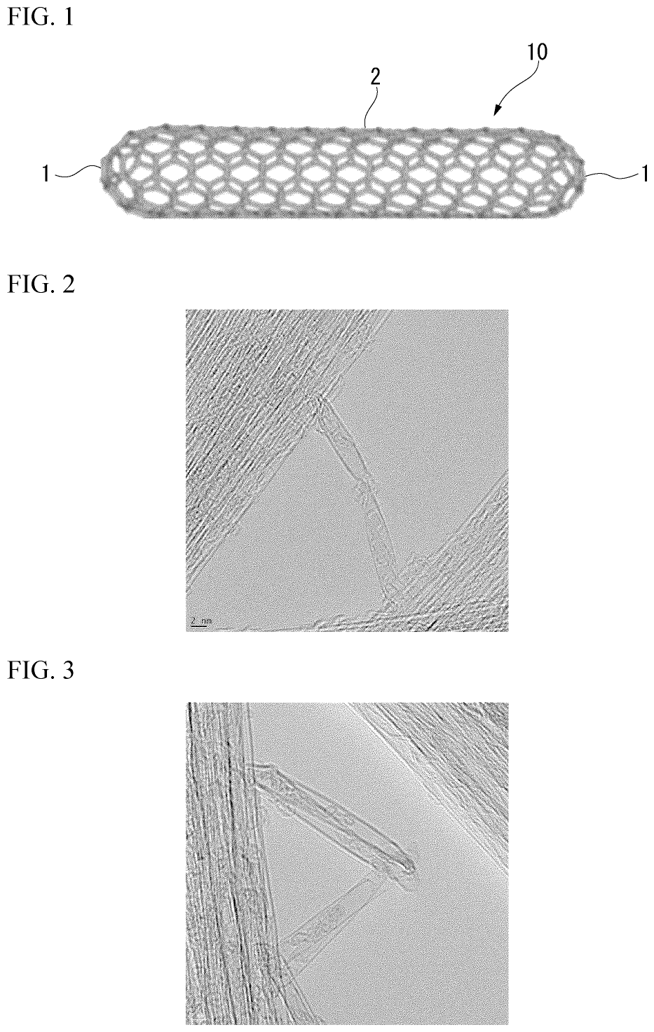

Hereinafter, a carbon nanotube structure and a method for producing a carbon nanotube structure according to embodiments of the present disclosure will be described with reference to FIGS. 1 to 15.

(Carbon Nanotube Structure)

The carbon nanotube structure according to the embodiment of the present disclosure includes a joining portion of end portions of carbon nanotubes and a joining portion of an end portion and a side wall portion of the carbon nanotubes.

(Carbon Nanotube)

As shown in FIG. 1, a carbon nanotube 10 has a cap-shaped end portion 1 and a cylindrical side wall portion 2. The carbon nanotube 10 mainly includes a six-membered ring in which carbon atoms are arranged in a hexagonal shape. The end portion 1 includes a five-membered ring in which carbon atoms are arranged in a pentagonal shape. A single-layer carbon nanotube has one cylinder, and a multi-layer carbon nanotube has a plurality of cylinders with different diameters stacked in a layer shape.

The carbon nanotube 10 in FIG. 1 is a single-layer carbon nanotube. In the following description, numbers assigned to FIG. 1 will be omitted.

Here, the carbon nanotubes constituting the carbon nanotube structure according to the embodiment of the present disclosure may be a single-layer carbon nanotube or a multi-layer carbon nanotube.

(Joining Portion)

In a case where the carbon nanotube structure according to the present disclosure is observed by a transmission electron microscope (TEM), as shown in FIGS. 2 and 3, the joining portion of the end portions of the carbon nanotubes and the joining portion of the end portion and the side wall portion of the carbon nanotubes can be observed. FIGS. 2 and 3 are observation images obtained by TEM observation by a method described below. FIG. 2 is a view showing a joining portion of an end portion of a single-layer carbon nanotube and an end portion of a single-layer carbon nanotube. FIG. 3 is a view showing a joining portion of an end portion of a single-layer carbon nanotube and a side wall portion of a single-layer carbon nanotube.

(Method of Observing Joining Portion)

A method of observing the joining portion in the carbon nanotube structure will be described.

As the TEM, for example, a transmission electron microscope JEOL 2100F with double spherical aberration correction, which is manufactured by JEOL Ltd., can be used. With an acceleration voltage set to 80 k, 15 to 20 fields are optionally captured in a range of 500,000 to 1,500,000 times magnification. On the obtained observation images, the presence or absence of the joining portion of the end portions of the carbon nanotubes and the joining portion of the end portion and the side wall portion of the carbon nanotubes are confirmed. In the obtained observation images, in a case where at least each one or more joining portions of the end portions of the carbon nanotubes or joining portions of the end portion and the side wall portion of the carbon nanotubes are observed, it is determined that the carbon nanotube structure includes the joining portion of the end portions of the carbon nanotubes and the joining portion of the end portion and the side wall portion of the carbon nanotubes.

The carbon nanotube structure according to the embodiment of the present disclosure may include a joining portion of the side wall portions of the carbon nanotubes.

(Nitrogen Adsorption Amount)

With regard to the carbon nanotube structure according to the embodiment of the present disclosure, in a nitrogen adsorption isotherm, in a case where a relative pressure P/P₀ is 0 to 0.3, a nitrogen adsorption amount is 100 ml (STP)/g or less. In other words, in the nitrogen adsorption isotherm, the nitrogen adsorption amount does not exceed 100 ml (STP)/g in the range in which the relative pressure P/P₀ is 0 to 0.3. The nitrogen adsorption isotherm can be obtained by a nitrogen gas adsorption method.

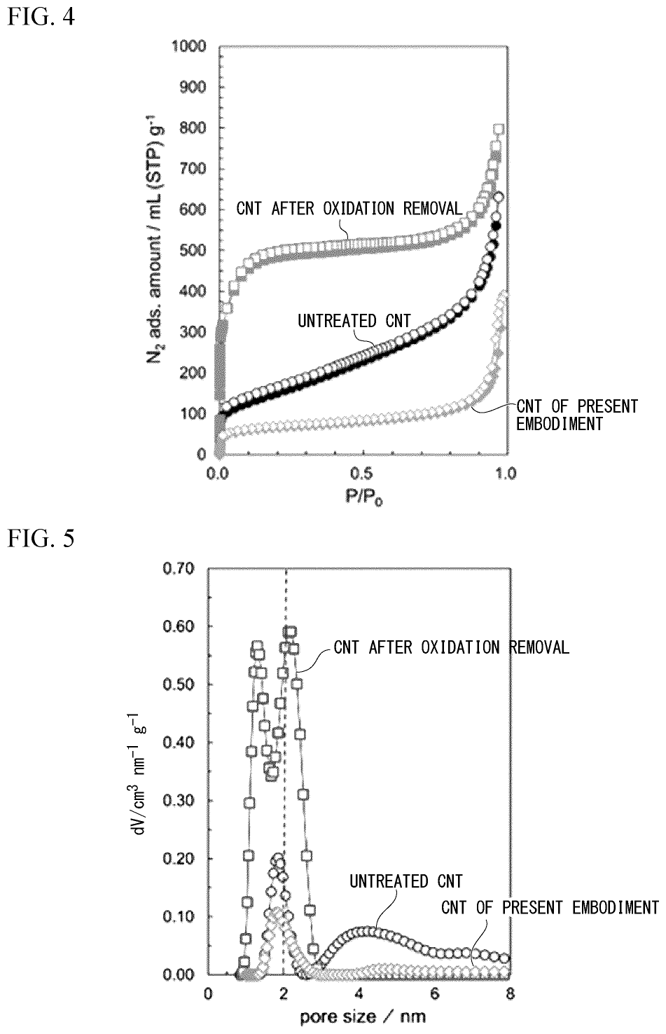

FIG. 4 is a nitrogen adsorption isotherms obtained by performing the nitrogen gas adsorption method on various aggregates of carbon nanotubes and carbon nanotube structures. According to FIG. 4, the carbon nanotube structure according to the embodiment of the present disclosure has a lower nitrogen adsorption amount than other examples, and it is found that, in the case where the relative pressure P/P₀ is 0 to 0.3, the nitrogen adsorption amount is 100 ml (STP)/g or less. On the other hand, in aggregates of untreated carbon nanotubes and aggregates of carbon nanotubes after the oxidation removal, it is found that the nitrogen adsorption amount increases as the relative pressure P/P₀ increases.

The nitrogen adsorption amount is substantially proportional to a surface area. That is, it is found that the carbon nanotube structure according to the embodiment of the present disclosure, which has a small nitrogen adsorption amount, has a smaller surface area than the other examples shown in FIG. 4. It is considered that this is because carbon nanotubes having pores at the end portion and the side wall portion are joined to each other so that the pores are blocked.

(Method of Measuring Nitrogen Adsorption Amount)

A method of measuring the nitrogen adsorption amount of the carbon nanotube structure will be described.

As an apparatus, for example, autosorb iQ2 (Quantachrome) manufactured by Anton Paar GmbH is used. A pretreatment is performed at 300 to 500 K for 2 to 4 hours, a measurement temperature is set to 77 K, and the nitrogen adsorption amount is measured by the nitrogen gas adsorption method. The nitrogen adsorption isotherm is obtained from the measured relative pressure and the measured nitrogen adsorption amount.

(Ratio of Nitrogen Adsorption Amount Before and After Joining)

With regard to the carbon nanotube structure according to the embodiment of the present disclosure, in the nitrogen adsorption isotherm, a value obtained by dividing a nitrogen adsorption amount in a case where the relative pressure P/P₀ is 0 to 0.3 by a nitrogen adsorption amount before joining is 0.1 to 0.3. It is considered that the reason why the nitrogen adsorption amount decreases after joining (after a joining step) is that the carbon nanotubes having pores at the end portion and the side wall portion are joined to each other, so that the pores are blocked and the surface area is reduced.

The ratio of the nitrogen adsorption amounts before and after joining is obtained by obtaining nitrogen adsorption isotherms before and after the joining step by the above-described method, and obtaining the ratio of the nitrogen adsorption amounts at each relative pressure P/P₀.

(Volume of Pores)

In the carbon nanotube structure according to the embodiment of the present disclosure, a volume of pores having a diameter of 2 nm may be 0.15 cm³/nm g or less.

FIG. 5 is a diagram obtained by measuring pores and pore volumes of various aggregates of carbon nanotubes and carbon nanotube structures. As shown in FIG. 5, in the carbon nanotube structure according to the embodiment of the present disclosure, a volume of pores having a diameter of 3 nm or more is small. In addition, the volume of pores having a diameter of 2 nm is smaller than in other examples. On the other hand, the aggregates of untreated carbon nanotubes and the aggregates of carbon nanotubes after the oxidation removal have large volume of pores having a diameter of 2 nm. In addition, the aggregates of untreated carbon nanotubes have large volume of pores having a diameter of 3 to 8 nm.

In the carbon nanotube structure according to the embodiment of the present disclosure, it is considered that the reason why the volume of pores having a diameter of 2 nm and the volume of pores having a diameter of 3 nm or more are small is that the carbon nanotubes having pores at the end portion and the side wall portion are joined to each other so that the pores are blocked.

(Measurement Method of Pore Volume and Pore Distribution)

The volume of pores is obtained by obtaining a nitrogen adsorption isotherm by the above-described nitrogen gas adsorption method, and obtaining a pore distribution by a density functional theory method (DFT method).

(Light Absorption Spectrum)

In the carbon nanotube structure according to the embodiment of the present disclosure, a difference between a first absorption peak and a first absorption peak before joining is 20 to 90 nm.

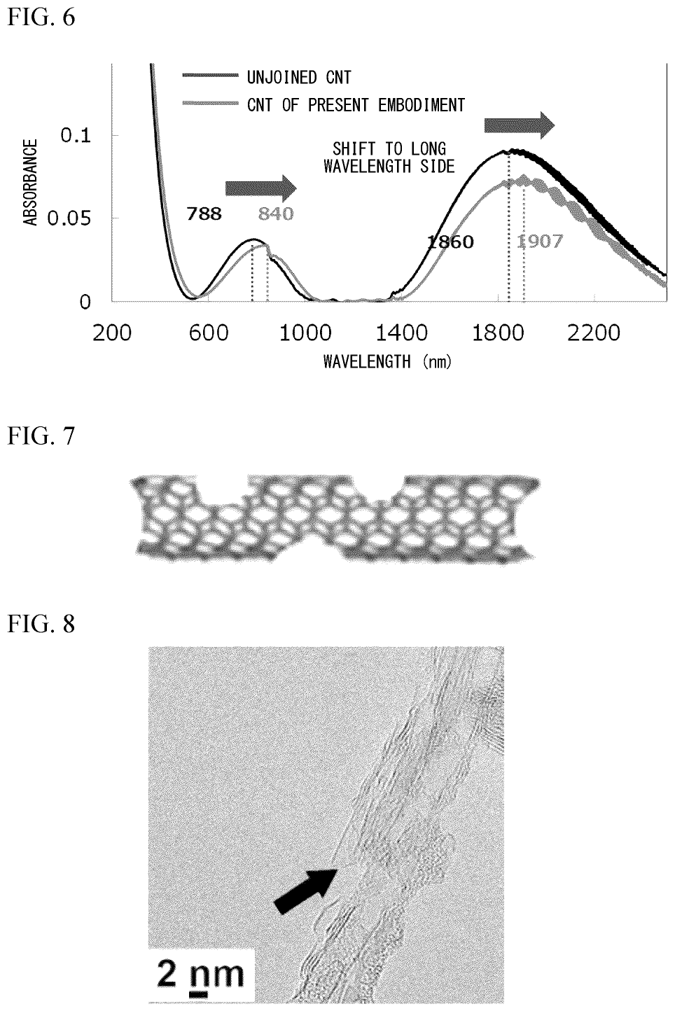

FIG. 6 is a diagram showing a light absorption spectrum of a carbon nanotube structure before and after the joining step. As shown in FIG. 6, it is found that the difference between a first absorption peak after the joining step (at a wavelength of 840 nm in FIG. 6) and a first absorption peak before the joining step (at a wavelength of 788 nm in FIG. 6) is 52 nm.

It is considered that the reason why the first absorption peak moves to a long wavelength side after going through the joining step is that an amide bond between the carbon nanotubes increases.

The presence or absence of the amide bond can be determined by obtaining an infrared absorption spectrum of the carbon nanotube structure.

(Method of Measuring Light Absorption Spectrum)

A method of measuring the light absorption spectrum will be described.

As an apparatus, for example, V-670 manufactured by JASCO Corporation is used. The light absorption spectrum is measured by setting a measurement range to 200 to 2500 nm, a scanning speed to 200 nm/min, and a measurement interval to 0.1 nm.

(Method for Producing Carbon Nanotube Structure)

The method for producing a carbon nanotube structure according to the embodiment of the present disclosure includes an oxidation removal step of oxidizing and removing end portions and side wall portions of carbon nanotubes and a joining step of joining the end portions of the carbon nanotubes and joining the end portion and the side wall portion of the carbon nanotubes to obtain a carbon nanotube structure.

(Oxidation Removal Step)

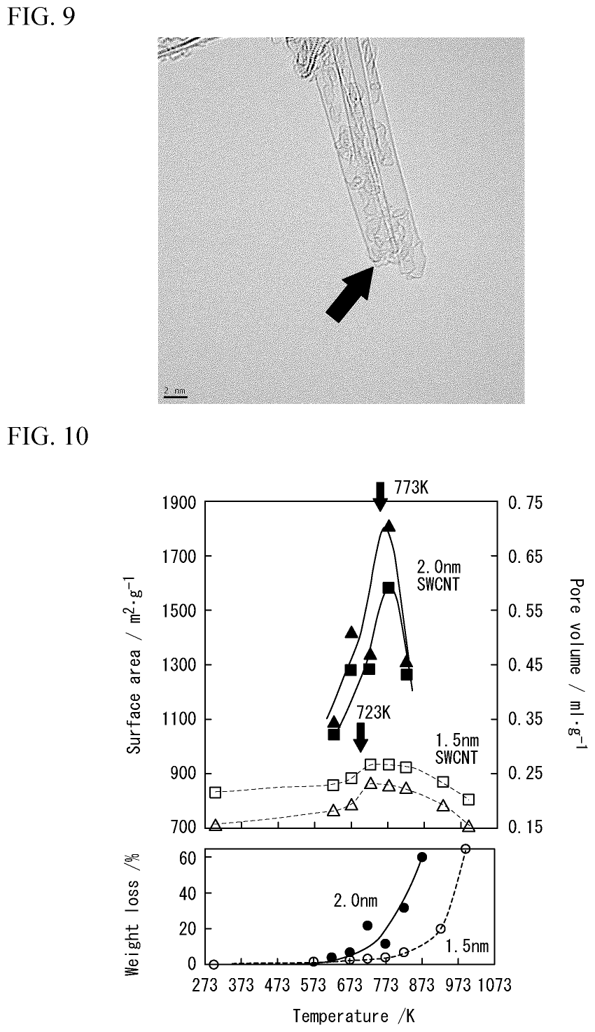

The oxidation removal step is a step of oxidizing and removing the end portions and the side wall portions of the carbon nanotubes. FIG. 7 is a schematic view of a single-layer carbon nanotube after the oxidation removal step. As shown in FIG. 7, by the oxidation removal step, the end portions of the single-layer carbon nanotube and a part of the side wall portions are oxidized and removed. FIGS. 8 and 9 are TEM images of the single-layer carbon nanotube after the oxidation removal step. In particular, in a case of looking at an arrow portion in FIG. 8, it is found that the end portion of the single-layer carbon nanotube is oxidized and removed.

The oxidation removal here refers to a cleavage of a carbon bond in the five-membered or six-membered ring of the carbon nanotube, and an addition of oxygen to the cleavage site for functionalization. The oxidation removal applies to both dry and wet types, and applies to both single-layer and multi-layer (two or more layers) carbon nanotubes.

As a method of oxidizing and removing the end portion and the side wall portion of the carbon nanotubes, dry oxidation removal or wet oxidation removal can be used.

(Dry Oxidation Removal)

Since the cap-shaped end portion of the carbon nanotube includes the five-membered ring having higher reactivity than the side wall portion, the end portion of the carbon nanotube is more likely to be oxidized by heating than the side wall portion. Therefore, in a case of the dry oxidation removal, the side wall portion of the carbon nanotube is also oxidized and removed, but the end portion of the carbon nanotube is preferentially oxidized and removed.

As the method of dry oxidation removal, for example, a method of putting the carbon nanotubes in a reaction tube and heating the reaction tube in an electric furnace while introducing dry air into the reaction tube is an exemplary example.

A degree of oxidation removal of the end portion and the side wall portion of the carbon nanotube can be controlled by adjusting the heating temperature, the oxygen concentration, and the heating time during the dry oxidation removal.

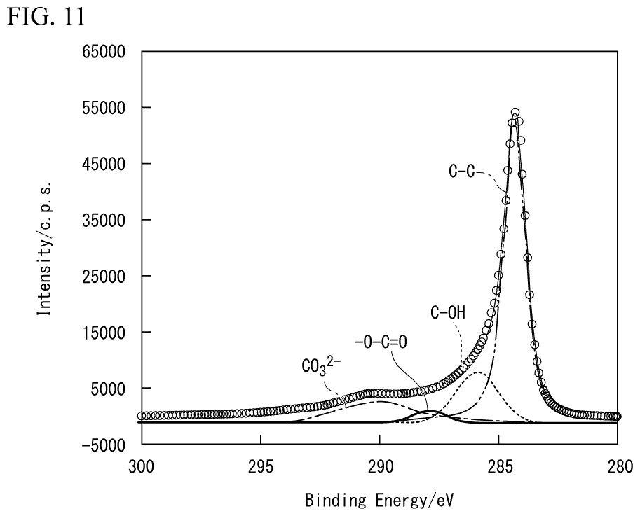

FIG. 10 is a diagram showing a relationship between a heating temperature, a weight loss rate, a surface area, and a pore volume in the dry oxidation removal. According to FIG. 10, a single-layer carbon nanotube having a diameter of 2.0 nm has the maximum surface area in a case where the heating temperature is 773 K, and a single-layer carbon nanotube having a diameter of 1.5 nm has the maximum surface area in a case where the heating temperature is 723 K, that is, it is found that amounts of oxidation removal at the end portion and the side wall portion correspond to a structure which makes maximum use of outer and inner surfaces of the carbon nanotube. In FIG. 10, triangular plots show the surface area, and square plots show the pore volume.

FIG. 11 is a diagram obtained by X-ray photoelectron spectroscopy (XPS) measurement of a carbon nanotube after being subjected to dry oxidation removal at 723 K. According to FIG. 11, it is found that the carbon nanotube is imparted with a functional group by the dry oxidation removal.

(Wet Oxidation Removal)

The wet oxidation removal is effective in oxidation removal of both the end portion and the side wall portion of the carbon nanotube. As a method of the wet oxidation removal, a method in which the carbon nanotube is immersed in an acidic solution, for example, in a hydrogen peroxide solution or a nitric acid aqueous solution, heated and stirred or refluxed to be uniformly oxidized and removed at a predetermined site, and filtered and washed is an exemplary example.

A degree of oxidation removal of the end portion and the side wall portion of the carbon nanotube can be controlled by controlling the concentration of the acidic solution, the reaction time, and the temperature. For example, in a case where the wet oxidation removal is performed using a 1 to 5 M nitric acid aqueous solution, the end portion and the side wall portion of the carbon nanotube can be sufficiently oxidized and removed by setting the reaction time to 4 hours or longer.

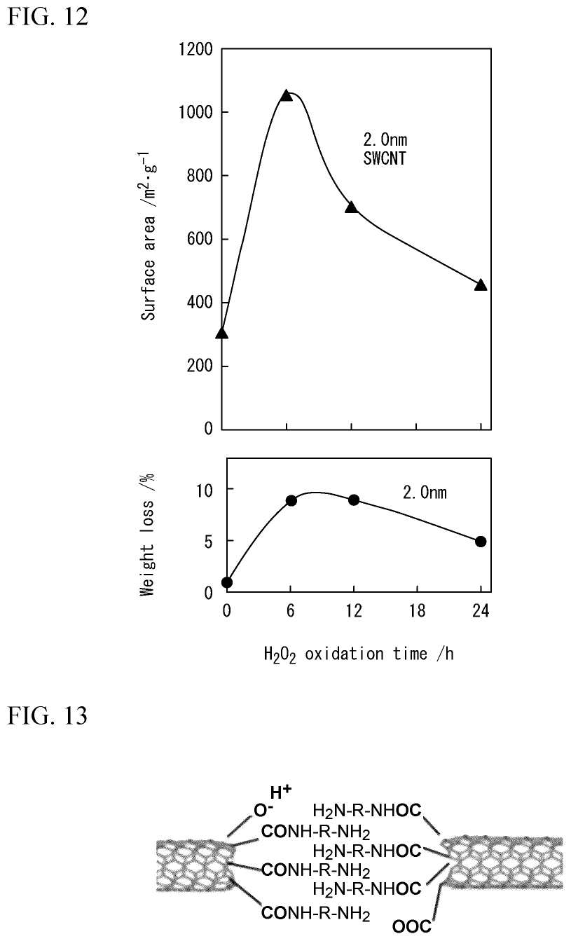

FIG. 12 is a relationship between a reaction time with a 30% hydrogen peroxide solution, a weight loss rate, and a surface area in the wet oxidation removal. According to FIG. 12, in a case where the wet oxidation removal is performed using a 30% hydrogen peroxide solution, the surface area is increased by setting the reaction time to 4 to 8 hours, and it is found that the end portion and the side wall portion of the carbon nanotube having a diameter of 2 nm can be sufficiently oxidized and removed.

In addition, according to FIG. 4 described above, since the carbon nanotube structure composed of the carbon nanotubes after the oxidation removal has a large nitrogen adsorption amount, it is found that the end portion and the side wall portion of the carbon nanotube have been oxidized and removed to increase the surface area over the carbon nanotube structure composed of untreated carbon nanotubes.

Furthermore, according to FIG. 5 described above, since the carbon nanotube structure composed of the carbon nanotubes after the oxidation removal has a large volume of pores having a diameter of 1 to 3 nm, it is found that the end portion and the side wall portion of the carbon nanotube are oxidized and removed.

(Joining Step)

The joining step is a step of joining the end portions of the carbon nanotubes oxidized and removed in the oxidation removal step and the end portion and the side wall portion of the carbon nanotube to obtain a carbon nanotube structure. The joining is carried out by mixing the carbon nanotube after the oxidation removal step or a dispersion step described later with a linker molecule. By mixing these substances, the oxidized and removed (functionalized) portions of the carbon nanotube are joined to each other by an amide bond. It should be noted that not all of the functionalized portions may be joined. That is, the functionalized portion may remain after the joining step.

As the linker molecule, a molecule in which two or more amino groups are bonded to a hydrocarbon or an aromatic compound is preferable. As the molecule in which two or more amino groups are bonded to a hydrocarbon, for example, NH₂—(CH₂)n-NH₂ is an exemplary example. n is preferably 2 to 18 and more preferably 2 to 12.

As the molecule in which two or more amino groups are bonded to an aromatic compound, 1,12-diaminododecane (DAD), 1,4-phenylenediamine (PDA), 3,3′-diaminobenzidine (DAB), 1,5-diaminonaphthalene (DAN), and 1,6-diaminopyrene (DAP) are exemplary examples.

In the joining step, the side wall portions of the carbon nanotubes may be joined in addition to the above-described sites. In addition, a tertiary amine and a joining reagent may be added multiple times and mixed, in addition to the carbon nanotube and the linker molecule. The tertiary amine is added to deprotonize the generated carboxylic acid at the end portion or the side wall portion of the carbon nanotube. The tertiary amine is not particularly limited as long as it is a tertiary amine, but is preferably triethylamine. By adding the joining reagent, it is possible to dewater and condense a carboxyl group present at the end portion and the side wall of the carbon nanotube and the amino group in the linker molecule to form the amide bond, thereby joining the carbon nanotubes. The reason why the addition is divided into a plurality of times is to allow the reaction of the solid carbon nanotube to proceed efficiently. The joining reagent is not particularly limited as long as it is a joining reagent, and for example, 1H-benzotriazol-1-yloxytris(dimethylamino)phosphonium hexafluorophosphate (BOP), (benzotriazol-1-yloxy)tripyrrolidinophosphonium hexafluorophosphate (PyBOP), 4-(4,6-dimethoxy-1,3,5-triazin-2-yl)-4-methylmorpholinium chloride (DMT-MM), or the like can be used.

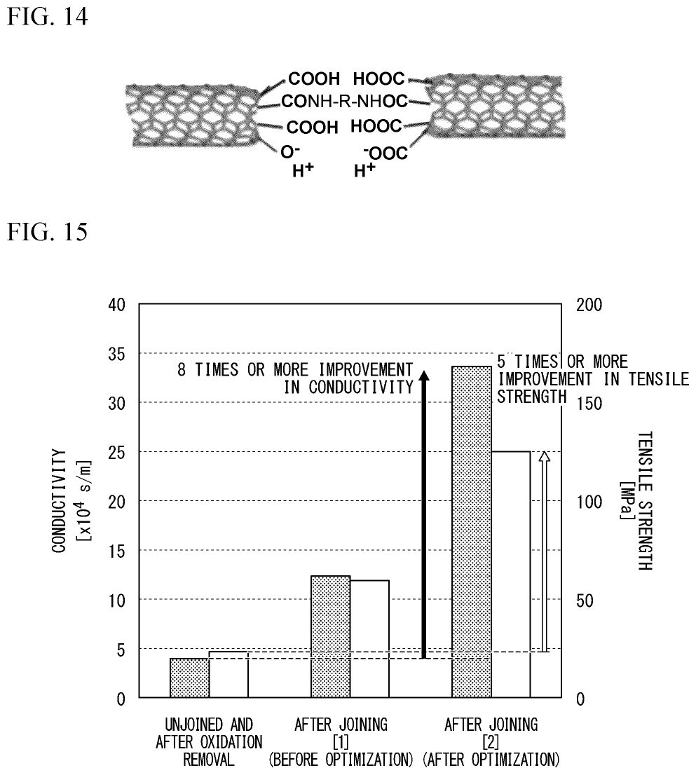

In addition, in the joining step, it is preferable that the amount of the linker molecule added is set to an appropriate amount. As shown in FIG. 13, in a case where the amount of the linker molecule added is too large, the number of bonded chains increases more than the functional groups imparted to the carbon nanotube, and the joining by the amide bond may insufficiently occur. As shown in FIG. 14, in a case where the amount of the linker molecule added is set to an appropriate amount, sufficient joining can occur by the amide bond.

FIG. 15 is a diagram showing conductivity and tensile strength of aggregates of carbon nanotubes before the joining (after the oxidation removal), a carbon nanotube structure after joining without an appropriate amount of the linker molecule added, and a carbon nanotube structure after joining with an appropriate amount of the linker molecule added. According to FIG. 15, the carbon nanotube structure after joining with an appropriate amount of the linker molecule added has approximately 8 times the conductivity compared to that of the aggregates of carbon nanotubes before the joining, has approximately 5 times the tensile strength compared to that of the aggregates of carbon nanotubes before the joining. In addition, with regard to the carbon nanotube structure after joining with an appropriate amount of the linker molecule added, it is found that the conductivity and the tensile strength are improved as compared with the carbon nanotube structure after joining without an appropriate amount of the linker molecule added.

(Dispersion Step)

The method for producing a carbon nanotube structure according to the embodiment of the present disclosure may include, before the oxidation removal step or between the oxidation removal step and the joining step, a dispersion step of dispersing aggregates (bundles) of the carbon nanotubes.

The carbon nanotubes easily form aggregates because the side wall portions of the carbon nanotubes are bonded to each other by a van der Waals force. By dispersing the aggregates of the carbon nanotubes, the joining can be more efficiently performed in the subsequent joining step.

In the dispersion step, aggregates of the carbon nanotubes and a dispersant are mixed. As the dispersant, a dispersant containing a metal salt of a first metal and a second metal can be used. As the first metal, for example, one or more selected from the group consisting of Zn, Ni, Cu, Ag, Mg, and Pd are exemplary examples. The second metal is a metal different from the first metal, and for example, one or more selected from the group consisting of Al, Fe, Co, Ag, Gd, Cu, Ni, Mg, Li, K, and Ca are exemplary examples. The dispersant which can be used in the embodiment according to the present disclosure may be an aqueous solvent or a non-aqueous solvent, or may be a mixture of an aqueous solvent and a non-aqueous solvent. As the non-aqueous solvent, chlorine-containing hydrocarbons (methylene chloride, chloroform, chlorobenzene, and the like), nitrogen-containing polar solvents (N,N-dimethylformamide, nitromethane, N-methylpyrrolidone, and the like), sulfur compounds (dimethyl sulfoxide and the like), or the like can be used.

The dispersant can be produced by heating a solution containing an acetate of the first metal and a nitrate or chloride salt of the second metal. As the acetate of the first metal, for example, one or more selected from the group consisting of zinc acetate (Zn(CH₃COO)₂·2H₂O), nickel acetate (Ni(CH₃COO)₂·4H₂O), copper acetate (Cu(CH₃COO)₂·H₂O), silver acetate (Ag(CH₃COO)₂), magnesium acetate (Mg(CH₃COO)₂·4H₂O), and palladium acetate (Pd(CH₃COO)₂) are exemplary examples. As the nitrate or chloride salt of the second metal, for example, one or more selected from the group consisting of aluminum nitrate (Al(NO₃)₃·9H₂O), iron nitrate (Fe(NO₃)₃·9H₂O), cobalt nitrate (Co(NO₃)₂·6H₂O), silver nitrate (AgNO₃), gadolinium nitrate (Gd(NO₃)₂·6H₂O), copper nitrate (Cu(NO₃)₂·3H₂O), nickel nitrate (Ni(NO₃)₂·6H₂O), magnesium nitrate (Mg(NO₃)₂·6H₂O), lithium nitrate (LiNO₃), potassium nitrate (KNO₃), calcium nitrate (Ca(NO₃)₂·4H₂O), aluminum chloride (AlCl₃·6H₂O), iron chloride (FeCl₃·6H₂O), cobalt chloride (CoCl₂·6H₂O), silver chloride (AgCl), gadolinium chloride (GdCl₂·6H₂O), copper chloride (CuCl₂·2H₂O), magnesium chloride (MgCl₂·6H₂O), lithium chloride (LiCl), potassium chloride (KCl), calcium chloride (CaCl₂·2H₂O), and nickel chloride (NiCl₂·6H₂O) are exemplary examples.

In the dispersion step, in order to disperse the aggregates of the carbon nanotubes, it is preferable that, after mixing the aggregates of the carbon nanotubes and the dispersant, a predetermined energy (vibration force, shear force, pressure, temperature, and the like) is applied from the outside.

(Sintering Step)

The method for producing a carbon nanotube structure according to the embodiment of the present disclosure may include a sintering step of sintering the carbon nanotube structure after the joining step. In the sintering step, the functional group of the joining portion joined in the joining step is removed to form a carbon-carbon bond.

By sintering the carbon nanotube structure, the strength of the carbon nanotube structure can be further increased.

The sintering method is not particularly limited, and for example, a method in which the carbon nanotube structure is preheated under reduced pressure conditions and then heated at 1200 to 2100 K for 2 to 15 hours is an exemplary example. As the preheating, for example, a method of heating in a temperature range of 500 to 680 K for 1 to 10 hours can be considered. In a case of heating at 1200 to 2100 K after the preheating, a heating rate is preferably set to 5 to 10 K/min.

(Action Effect)

Since the carbon nanotube structure having the above-described configuration includes the joining portion of the end portions of the carbon nanotubes and the joining portion of the end portion and the side wall portion of the carbon nanotubes, it is possible to easily produce a three-dimensional structure using the carbon nanotube structure.

In addition, as in Patent Document 1 described above, in a case where the carbon nanotubes are joined by the ester bond, the carbon nanotube structure is easily decomposed by an acid or an alkali. However, in the carbon nanotube structure having the above-described configuration, since the carbon nanotubes are joined by the amide bond, the carbon nanotube structure is not easily decomposed by an acid or an alkali.

Since the method for producing a carbon nanotube structure of the above-described configuration includes the oxidation removal step of oxidizing and removing end portions and side wall portions of carbon nanotubes and the joining step of joining the end portions of the carbon nanotubes and joining the end portion and the side wall portion of the carbon nanotubes to obtain a carbon nanotube structure, it is possible to produce a carbon nanotube structure which can be suitably applied to the production of a three-dimensional structure.

In addition, since the method for producing a carbon nanotube structure of the above-described configuration includes, before the oxidation removal step or between the oxidation removal step and the joining step, the dispersion step of dispersing aggregates of the carbon nanotubes, the joining can be performed more efficiently in the subsequent joining step.

In addition, since the method for producing a carbon nanotube structure of the above-described configuration includes the sintering step of sintering the carbon nanotube structure after the joining step, the strength of the carbon nanotube structure can be further increased.

While preferred embodiments of the invention have been described and illustrated above, it should be understood that these are exemplary examples of the invention and are not to be considered as limiting. Additions, omissions, substitutions, and other modifications can be made without departing from the scope of the invention. Accordingly, the invention is not to be considered as being limited by the foregoing description and is only limited by the scope of the appended claims.

The carbon nanotube structure according to the embodiment of the present disclosure can be suitably used as windings for small transformers; small and high-output motors; generators for electric vehicles, naval ships, electric aircraft, and the like; composite resins with improved heat resistance; and heat dissipation materials.

<Appendix>

The carbon nanotube structure described in each embodiment is understood as follows, for example.

The carbon nanotube structure according to the first aspect of the present disclosure is a carbon nanotube structure in which a plurality of carbon nanotubes 10 are assembled, the carbon nanotube structure including a joining portion of end portions 1 of the carbon nanotubes 10 and a joining portion of the end portion 1 and a side wall portion 2 of the carbon nanotubes 10.

Since the carbon nanotube structure having the above-described configuration includes the joining portion of the end portions 1 of the carbon nanotubes 10 and the joining portion of the end portion 1 and the side wall portion 2 of the carbon nanotubes 10, the carbon nanotube structure can be suitably used for producing a three-dimensional structure.

In addition, since the carbon nanotubes 10 are joined by an amide bond, the carbon nanotube structure is not easily decomposed by an acid or an alkali.

With regard to the carbon nanotube structure according to the second aspect, in a nitrogen adsorption isotherm, in a case where a relative pressure P/P₀ is 0 to 0.3, a nitrogen adsorption amount is 100 ml (STP)/g or less. This is because the carbon nanotubes 10 having pores at the end portion 1 and the side wall portion 2 are joined to each other so that the pores are blocked.

In the carbon nanotube structure according to the third aspect, a difference between a first absorption peak and a first absorption peak before joining is 20 to 90 nm. This is because the carbon nanotubes 10 are joined by an amide bond.

With regard to the carbon nanotube structure according to the fourth aspect, in a nitrogen adsorption isotherm, a value obtained by dividing a nitrogen adsorption amount in a case where a relative pressure P/P₀ is 0 to 0.3 by a nitrogen adsorption amount before joining is 0.1 to 0.3. This is because the carbon nanotubes 10 having pores at the end portion 1 and the side wall portion 2 are joined to each other so that the pores are blocked.

The method for producing a carbon nanotube structure, described in each embodiment, are understood as follows, for example.

The method for producing a carbon nanotube structure according to the first aspect is a method for producing a carbon nanotube structure in which a plurality of carbon nanotubes 10 are assembled, the method including an oxidation removal step of oxidizing and removing end portions 1 and side wall portions 2 of the carbon nanotubes 10 and a joining step of joining the end portions 1 of the carbon nanotubes 10 and joining the end portion 1 and the side wall portion 2 of the carbon nanotubes 10 to obtain a carbon nanotube structure.

With the method for producing a carbon nanotube structure of the above-described configuration, it is possible to produce a carbon nanotube structure including a joining portion of the end portions 1 of the carbon nanotube 10 and a joining portion of the end portion 1 and the side wall portion 2 of the carbon nanotube 10. Therefore, a carbon nanotube structure which can be suitably used for producing a three-dimensional structure can be produced.

In addition, since a carbon nanotube structure in which the carbon nanotubes 10 are joined by an amide bond can be produced, it is possible to produce a carbon nanotube structure which is hardly decomposed by an acid or an alkali.

The method for producing a carbon nanotube structure according to the second aspect includes, before the oxidation removal step or between the oxidation removal step and the joining step, a dispersion step of dispersing aggregates of the carbon nanotubes 10.

In the method for producing a carbon nanotube structure of the above-described configuration, by dispersing the aggregates of the carbon nanotubes 10, the joining can be more efficiently performed in the subsequent joining step.

The method for producing a carbon nanotube structure according to the third aspect includes a sintering step of sintering the carbon nanotube structure after the joining step.

In the method for producing a carbon nanotube structure of the above-described configuration, by sintering the carbon nanotube structure, the strength of the carbon nanotube structure can be further increased.

### EXAMPLES

Examples will be described below, but the conditions in Examples are one condition examples adopted for confirming practicability and effects of the embodiments of the present disclosure, and the embodiments of the present disclosure are not limited to the one condition examples.

Aggregates of single-layer carbon nanotubes were heated in dry air to 450 to 750 K at a heating rate of 2 to 10 K/min (dry oxidation removal) to oxidize and remove an end portion and a side wall portion of the carbon nanotubes. Next, using a magnet stirrer, a mixed solution of a dispersion of dichloromethane and dimethylformamide and the aggregates of the carbon nanotubes were stirred for 30 minutes. After the stirring, it was visually confirmed that the aggregates of the carbon nanotubes were dispersed.

Next, joining of the carbon nanotubes was performed by mixing the dispersed carbon nanotubes, a linker molecule, triethylamine, and a joining reagent. As the linker molecule, 1,4-phenylenediamine (PDA) and 3,3′-diaminobenzidine (DAB) were used. As the joining reagent, 1H-benzotriazol-1-yloxytris(dimethylamino)phosphonium hexafluorophosphate (BOP) was used. The linker molecule, triethylamine, and joining reagent were added in multiple times of 0.5 M each.

A carbon nanotube structure was obtained by the above-described method.

With the carbon nanotube structure after the joining, the carbon nanotube before the joining (after the oxidation removal and after the dispersion), and the aggregates of carbon nanotubes before the oxidation removal (untreated), by the above-described method, a nitrogen adsorption isotherm and a diagram showing a relationship between pores and a pore volume were obtained.

In addition, with the carbon nanotube structure after the joining and the carbon nanotube before the joining (after the oxidation removal and after the dispersion), an infrared absorption spectrum was obtained by a measurement under the following conditions.

Measurement method: KBr tablet method (p: 7 mm)

Sample concentration: 0.2 wt % CNT

Measurement range: 4000 cm⁻¹ to 500 cm⁻¹

Resolution: 1 cm⁻¹

Number of times of integration: 1024 times

Measurement atmosphere: nitrogen

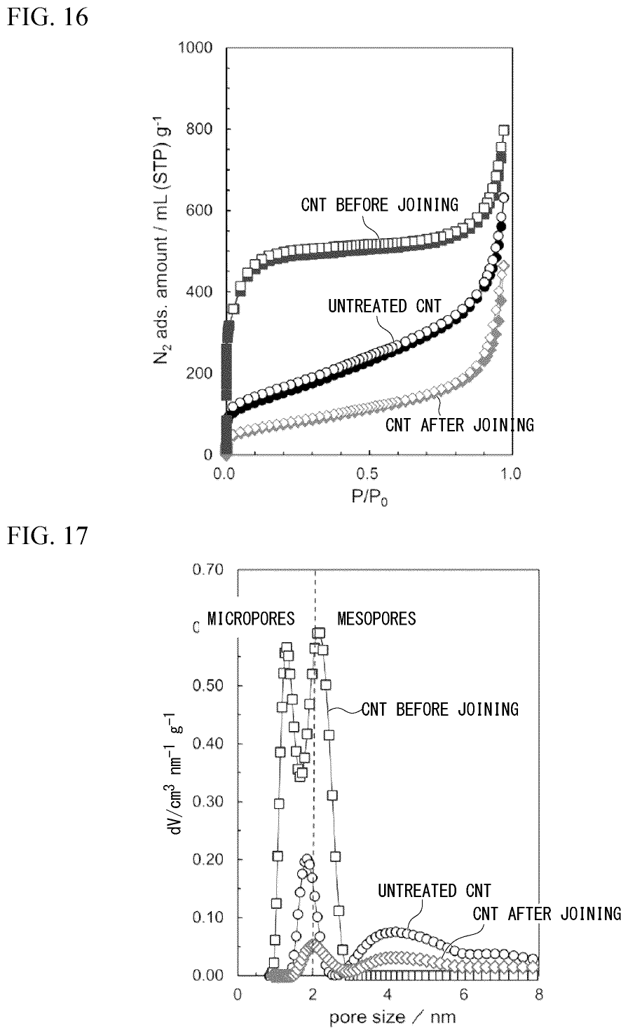

FIG. 16 shows the nitrogen adsorption isotherm. According to FIG. 16, it was found that the carbon nanotube structure (CNT after the joining) obtained in the present example had a lower nitrogen adsorption amount, that is, a smaller surface area than in other examples. As a result, it was found that the end portion and the side wall portion of the carbon nanotube were joined to each other, so that the pores formed at these portions were blocked.

FIG. 17 shows a diagram showing the relationship between the pores and the pore volume. According to FIG. 17, in the carbon nanotube structure obtained in the present example, it was found that the volume of pores having a diameter of 3 nm or more was small and the volume of pores having a diameter of 2 nm was smaller as compared with other examples. On the other hand, it was found that the untreated carbon nanotube and the carbon nanotube before the joining had large volumes of pores having a diameter of 2 nm. In addition, it was found that the untreated carbon nanotube had a large volume of pores having a diameter of 3 to 8 nm.

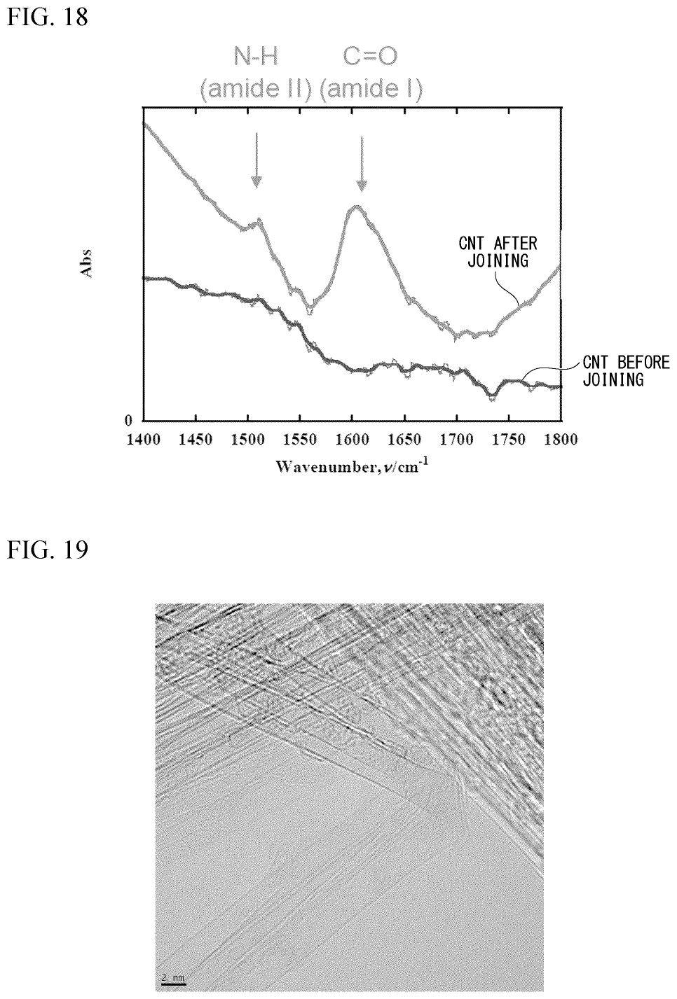

FIG. 18 shows the infrared absorption spectrum. According to FIG. 18, it was found that the carbon nanotube structure after the joining had an amide bond.

Next, the obtained carbon nanotube structure was sintered. For the sintering, the obtained carbon nanotube structure was preheated at 500 to 680 K for 10 hours under a reduced pressure condition, and then heated at a temperature of 1273 to 2073 K for 1 to 5 minutes with a heating rate of 5 to 10 K/min. For the sintering, an electric furnace of an ultra-high temperature vacuum atmosphere furnace NEWTONIAN Pascal-40 VP04-A45 manufactured by NAGANO Co., ltd. was used.

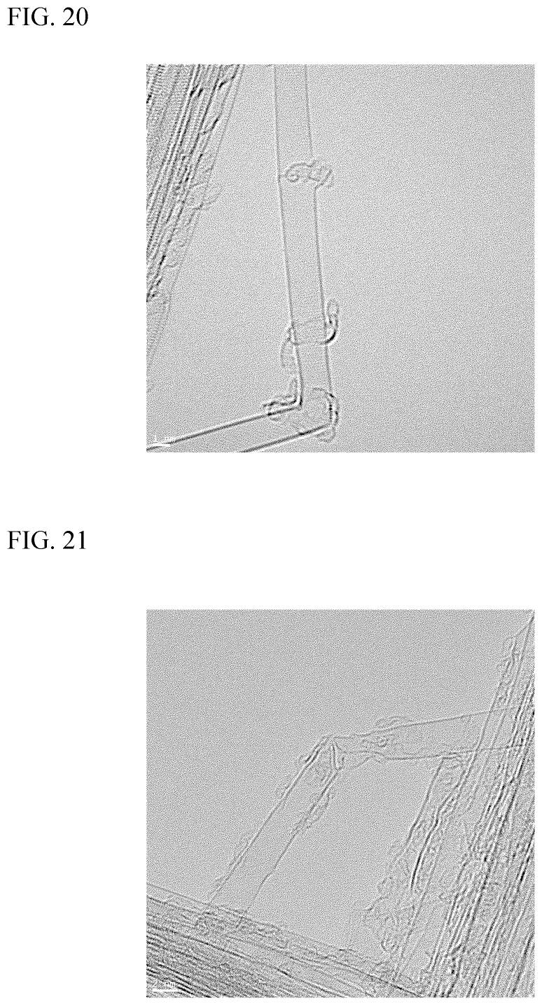

After the sintering, the joining portions were confirmed by TEM observation. FIGS. 19 to 21 show captured images obtained by the TEM observation. According to FIGS. 18 to 21, it could be confirmed that the carbon nanotubes were joined to each other.

### INDUSTRIAL APPLICABILITY

With the carbon nanotube structure and the method for producing a carbon nanotube structure according to the aspects of the present disclosure, it is possible to provide a carbon nanotube structure and a method for producing a carbon nanotube structure, in which a three-dimensional structure can be easily produced.

### REFERENCE SIGNS LIST

1: End portion
2: Side wall portion
10: Carbon nanotube

1. A carbon nanotube structure in which a plurality of carbon nanotubes are assembled, the carbon nanotube structure comprising, between carbon nanotubes:
a joining portion of end portions of the carbon nanotubes; and
a joining portion of an end portion and a side wall portion of the carbon nanotubes.

2. The carbon nanotube structure according to claim 1,
wherein, in a nitrogen adsorption isotherm, in a case where a relative pressure P/P₀ is 0 to 0.3, a nitrogen adsorption amount is 100 ml (STP)/g or less.

3. The carbon nanotube structure according to claim 1,
wherein a difference between a first absorption peak and a first absorption peak before joining is 20 to 90 nm.

4. The carbon nanotube structure according to claim 1,
wherein, in a nitrogen adsorption isotherm, a value obtained by dividing a nitrogen adsorption amount in a case where a relative pressure P/P₀ is 0 to 0.3 by a nitrogen adsorption amount before joining is 0.1 to 0.3.

5. A method for producing a carbon nanotube structure in which a plurality of carbon nanotubes are assembled, the method comprising:
an oxidation removal step of oxidizing and removing end portions and side wall portions of carbon nanotubes between the carbon nanotubes; and
a joining step of joining the end portions of the carbon nanotubes and joining the end portion and the side wall portion of the carbon nanotubes to obtain a carbon nanotube structure.

6. The method for producing a carbon nanotube structure according to claim 5,
wherein the method includes, before the oxidation removal step or between the oxidation removal step and the joining step, a dispersion step of dispersing aggregates of the carbon nanotubes.

7. The method for producing a carbon nanotube structure according to claim 5,
wherein the method includes, after the joining step, a sintering step of sintering the carbon nanotube structure.
